(19) United States
(12) Patent Application Publication
(10) Pub. No.: US 2026/0128436 A1
(43) Pub. Date: May 7, 2026

(54) BATTERY CASING, PRODUCED AS A LARGE CAST PART, FOR A MOTOR VEHICLE, AND MOTOR VEHICLE HAVING A BATTERY CASING OF THIS KIND

(71) Applicant: Volkswagen Aktiengesellschaft, Wolfsburg (DE)

(72) Inventors: Stefan REINSCH, Lehre (DE); Matthias GRAUL, Brome (DE); Johannes SPERBER, Wolfsburg (DE)

(73) Assignee: Volkswagen Aktiengesellschaft, Wolfsburg (DE)

(21) Appl. No.: 19/426,872

(22) Filed: Dec. 19, 2025

Related U.S. Application Data
(63) Continuation of application No. PCT/EP2024/061304, filed on Apr. 24, 2024.

(30) Foreign Application Priority Data
Jun. 19, 2023 (DE) 10 2023 205 724.7

(51) Int. Cl. H01M 50/242; B60K 1/00; B60K 1/04; H01M 50/224; H01M 50/249; H01M 50/289

(52) U.S. Cl. CPC H01M 50/242; B60K 1/04; H01M 50/224; H01M 50/249; H01M 50/289; B60K 2001/005; B60K 2001/0438

(57) ABSTRACT

A battery casing, produced as a large cast part, for a motor vehicle, having a bottom portion that has a width extending in the vehicle transverse direction and a length extending in the vehicle longitudinal direction, and having at least one side wall that extends upward in the vehicle vertical direction, outside of the bottom portion, in order to laterally delimit, at least on one side, an interior for arranging battery cells and/or battery modules on the bottom portion. At least one additional wall extends upward from the bottom portion or extending outward, in relation to the area of the interior, from the bottom portion and is formed as a protective element.

This nonprovisional application is a continuation of International Application No. PCT/EP2024/061304, which was filed on Apr. 24, 2024, and which claims priority to German Patent Application No. 10 2023 205 724.7, which was filed in Germany on Jun. 19, 2023, and which are both herein incorporated by reference.

### BACKGROUND OF THE INVENTION

### Field of the Invention

The invention relates to a battery casing, produced as a large cast part, for a motor vehicle, which extends across a major part of the vehicle width extending in the vehicle transverse direction (y direction) of a motor vehicle for which the battery casing is intended. In addition, the invention relates to a motor vehicle having at least one such battery casing.

### Description of the Background Art

A battery casing cover that is produced as a cast aluminum part for a motor vehicle is known from KR 20200126843 A. This battery casing cover has a groove for a seal, screw holes, and screw points, which are integrally molded.

An energy storage unit for a motor vehicle, a mounting arrangement of such an energy storage unit on a body of a motor vehicle, and a motor vehicle having such an energy storage unit are known from DE 10 2017 011 994 B3, which corresponds to US 2021/0016649. In this case, the energy storage unit is or can be reversibly and detachably mounted on a body of the motor vehicle, wherein the energy storage unit also has a support frame. The support frame is composed of longitudinal member elements and cross member elements that are produced individually and connected to one another to form a ladder-like structure. The longitudinal member elements and cross member elements are designed as load paths in some cases. No reference is made in the document to a battery casing produced as a large cast part.

A battery casing for a battery module, as well as a battery module having a battery casing, and a vehicle are known from DE 10 2020 210 202 A1, which corresponds to US 2022/052395. This battery casing has the size of a battery module and is rather small in comparison with a motor vehicle. It is disclosed that the battery casing can be created in a sandwich construction by means of a die-cast part, and structures for increasing crash safety and temperature control areas can be provided in the casing side walls. No reference is made in the document to a battery casing produced as a large cast part.

### SUMMARY OF THE INVENTION

It is therefore an object of the present invention is to provide a battery casing, produced as a large cast part, for a motor vehicle, as well as a motor vehicle having such a battery casing, that permit simple production and assembly and that permit reliable arrangement and operation of battery cells and/or battery modules in the battery casing.

A major part of the vehicle width can mean a width of at least 50 percent, preferably at least 70 percent, further preferably at least 80 percent, and especially preferably at least 90 percent.

A battery casing according to the invention, produced as a large cast part, for a motor vehicle, includes a bottom portion that has a width extending in the vehicle transverse direction and a length extending in the vehicle longitudinal direction. Furthermore, at least one side wall is formed that extends upward in the vehicle vertical direction, outside of the bottom portion, in order to laterally delimit, at least on one side, an interior for arranging battery cells and/or battery modules on the bottom portion. In addition, at least one additional wall extending upward from the bottom portion or extending outward, in relation to the area of the interior, from the bottom portion is formed as a protective element. As a whole, the result is thus a receiving structure for battery cells and/or battery modules that is produced as a large cast part and hence in one piece, and that, with the bottom portion and the at least one side wall, not only provides a protected receiving space for battery cells and/or battery modules but also has at least one protective element formed in one piece with the battery casing. A battery casing of this nature can be produced with high precision and has the advantage over battery casings made of individual parts that it has very small manufacturing tolerances. Assembly tolerances and assembly-related defects are eliminated. In summary, an integral battery casing is formed that permits reliable arrangement and reliable operation of battery cells and/or battery modules. Furthermore, fewer joining methods or fewer joining operations are needed to produce the battery casing according to the invention. In addition, battery casings according to the invention have better recyclability.

A bottom portion within the meaning of the invention can be understood, for example, as a structure designed in the manner of a plate with a flat surface for arranging battery cells and/or battery modules. The bottom portion preferably has a rectangular basic shape.

A side wall within the meaning of the invention can be understood, in particular, as a structure extending upward from the bottom portion, on the outside, that permits a reliable lateral enclosing of battery cells and/or battery modules. Preferably, the height of the side wall is chosen such that it corresponds at least to the height of the battery cells and/or the battery modules so that the battery cells and/or battery modules are completely overtopped in the vertical direction by the side wall. Preferably, a full-perimeter side wall is provided. However, it is also possible to provide only a side wall on each side, on the outside, each of which side walls extends in the vehicle longitudinal direction. This is especially advantageous when the bottom portion is enclosed at the front and/or rear by other elements that can take on the function of a front wall and/or a rear wall.

The at least one additional wall can extend upward in the vehicle vertical direction from the bottom portion and is designed as a load path extending completely through the interior. In this case, an especially high stiffness of the battery casing is produced on account of the resultant load path. In this connection, particular mention is made of the possibility to achieve a longitudinal load path by forming an additional wall extending completely over the vehicle longitudinal direction of the bottom portion. Analogously, a transverse load path can be achieved by forming an additional wall extending completely across the vehicle transverse direction of the bottom portion. Diagonal load paths can also be achieved with the aid of an additional wall, in particular by forming an additional wall that extends diagonally through a battery casing. Load path can be understood as all additional walls that extend from a first attachment point at a side wall to a second attachment point of a side wall of the battery casing. Additional walls with a linear design and additional walls with an arched design having an approximately uniform curvature are preferred for manufacturing-related reasons. Good load distribution is achieved with such additional walls.

The at least one additional wall can also extend outward in the vehicle transverse direction, outside of the bottom portion, and is designed as a crash element. In this case, battery cells and/or battery modules arranged in the battery casing can be protected effectively from intrusion forces with the aid of the additional wall designed as a crash element, in particular when the additional wall is configured for the efficient absorption of kinetic energy. This can be realized, in particular, by the means that the additional wall is designed as a crash structure extending outward by at least 5 cm, preferably at least 10 cm, and further preferably at least 15 cm compared with the side wall.

Please note that the wall thickness of a crash structure as described above can be designed to be variable, on the one hand to simplify production in the casting process, but also on the other hand for the purpose of designing the crash behavior. Thus, for example, a wall thickness can be provided that increases from the outside toward the vehicle center, in particular a wall thickness that increases continuously. Slopes for increasing the wall thickness with angles of additional walls relative to the central axis oriented in the vehicle transverse direction (y direction) between 2° and 20°, in particular between 3° and 10°, are preferred.

Another possibility for influencing the crash behavior of the additional walls extending outward in the vehicle transverse direction is to preweaken them or ensure a specific component failure by means of holes, chamfers, perforations, or other structural design options. In this regard, structural possibilities for ensuring crease buckling or crushing are mentioned, in particular.

One additional wall can be designed as a crash element or multiple additional walls can be designed as crash elements, on every side facing outward in the vehicle transverse direction. It is preferred that the same additional wall on both the left and right sides of the battery casing is designed as a crash element so that the same protective effect is produced on both sides. Multiple additional walls, for example two, three, or more additional walls arranged parallel to one another, can also be provided on one side or on both sides, resulting in a forklike geometry in which each additional wall forms a prong of the fork in a view from the front. In this case, the respective additional walls (fork prongs) preferably are designed such that a controlled crumpling behavior or failure behavior is produced owing to crease buckling or crushing, in order to absorb as much energy as possible through deformation or destruction, in the event that a force acts from outside on the respective end faces.

Further, it is noted that the measures described above in connection with the right and left vehicle sides can, alternatively or in addition, also be implemented analogously in the region of a vehicle front end and/or a vehicle rear end.

When the at least one additional wall designed as a crash element is composed of a multiplicity of closed substructures, a crash structure can be provided that has only a low weight on the one hand, but can also absorb high energy on the other hand. Closed substructures can be understood to mean, in particular, hollow structures that have a closed shape, for example a polygonal or round shape. In this context, a round shape can be understood to mean not only circular geometries, but also oval or otherwise shaped structures that have no directional changes in the form of corners.

The substructures can be arranged directly adjacent to one another in such a manner that a largely homogeneous overall structure is produced. In this context, particular mention is made of square, honeycomb, rectangular, and round structures, which produce a largely homogeneous overall structure when directly adjacent to one another. In this case, forces acting from outside, such as can occur in a lateral collision, in particular, are absorbed approximately uniformly over the entire length, regardless of the impact position.

The substructures can also be spaced apart from one another by connecting structures in such a manner that a nonhomogeneous overall structure is produced. Such a configuration is especially useful when the existence of other protective structures extending over only a part of the length of the battery casing is to be taken into account with the aid of the nonhomogeneity in order to design the substructures in an especially weight-saving manner utilizing these protective structures. In this case, the substructures can be arranged less densely in places in a vehicle where other protective structures are already located, for example in the region of an A-pillar, a B-pillar, or another protective structure, and be arranged more densely in places in a vehicle where no other protective structures are located in order to thus achieve, on the whole, an approximately uniform protective effect with respect to forces acting laterally on the battery casing.

A fluid channel can be formed in the at least one additional wall, at least in some places. This has the advantage that the fluid channel can be used for active cooling of battery cells and/or battery modules arranged in the battery casing. The channel can be formed by arranging a lost core or by arranging multiple lost cores completely in one additional wall or multiple additional walls. The fluidic elements can also be formed or arranged within the fluid channel, in particular fins or other elements that influence the fluid channel in terms of flow. Furthermore, structure-stiffening elements can also be formed or arranged inside the fluid channel.

Especially simple manufacture of a battery casing according to the invention having at least one fluid channel occurs when the fluid channel is created by forming a unilaterally open cavity in the additional wall and by fluid-tight sealing of the cavity with at least one separate element. In this case, production by casting is possible even without lost cores and is simplified in this respect. Furthermore, the unilaterally open cavity permits the subsequent arranging of auxiliary elements such as, e.g., fins, before the cavity is sealed with the separate element.

At least one additional wall can be designed as a longitudinal load path and at least one additional wall can be designed as a transverse load path. In this case, the two intersecting load paths produce a structure that is especially inherently stiff and that meets high crash requirements.

At least one fluid path can be formed that extends through the side wall and at least one additional wall. In this case, the side wall, preferably both side walls extending in the vehicle longitudinal direction, and one or more additional walls, preferably all additional walls designed as transverse load paths, can be used as a channel structure inasmuch as fluid can be introduced through one of the side walls, and the fluid is conducted through the additional walls to cool the battery cells and/or battery modules arranged in the battery casing and is conducted back out of the other of the side walls. In this case, a channel structure is created with the aid of the side walls and with the aid of one additional wall or multiple additional walls.

The invention also relates to a motor vehicle having a battery casing as described above, wherein the battery casing extends across a major part of the width of the motor vehicle. A major part of the width of the motor vehicle can be understood in this context as, in particular, at least 50 percent of the entire maximum width of the motor vehicle. Preferably, the battery casing extends to the greatest possible extent (i.e., at least 80 percent) across the region between the side sills of a motor vehicle, especially preferably completely across the region between the side sills.

In absolute dimensions, the width of a battery casing according to the invention can be at least 500 mm, preferred at least 800 mm, further preferred at least 1,000 mm, and especially preferred at least 1,200 mm.

The length of a battery casing according to the invention can be at least 750 mm, preferred at least 1,000 mm, further preferred at least 1,200 mm, further preferred at least 1,500 mm, and especially preferred at least 2,000 mm.

The wall thickness of a battery casing according to the invention can be at least 2 mm. If cavities are provided for fluid channels, the cavities can have a minimum width of 2 mm, preferred at least 3 mm or even at least 5 mm. The height of a fluid channel preferably is chosen at least such that the fluid channel in the vertical direction (z direction) extends at least over the same height as an adjacently located battery module or an adjacently located battery cell. In absolute dimensions, the height is preferably 5 mm, further preferred at least 8 mm, and especially preferred at least 10 mm.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a body shell of a motor vehicle with a battery casing that extends completely across the region between the side sills, in an isometric representation obliquely from above,

FIG. 2 is a battery casing with fluid channels formed in additional walls, in a longitudinal sectional view,

FIG. 3 is a battery casing with additional walls designed as crash elements, in a cross-sectional view,

FIG. 4 is an additional wall designed as a crash element with closed substructures, analogous to the representation in FIG. 3, in a view corresponding to the arrow IV in FIG. 3,

FIG. 5 is another additional wall designed as a crash element with closed substructures, analogous to the representation in FIG. 3, in a view corresponding to the arrow IV in FIG. 3,

FIG. 6 is another additional wall designed as a crash element with closed substructures, analogous to the representation in FIG. 3, in a view corresponding to the arrow IV in FIG. 3,

FIG. 7 is an additional wall designed as a crash element with two separate rows of substructures, analogous to the representation in FIG. 3, in a view corresponding to the arrow IV in FIG. 3,

FIG. 8 is another additional wall designed as a crash element with closed substructures that are spaced apart from one another and with connecting structures, analogous to the representation in FIG. 3, in a view corresponding to the arrow IV in FIG. 3, and

FIG. 9 is another additional wall designed as a crash element with closed substructures that are spaced apart from one another, and open structures around the substructures, analogous to the representation in FIG. 3, in a view corresponding to the arrow IV in FIG. 3.

### DETAILED DESCRIPTION

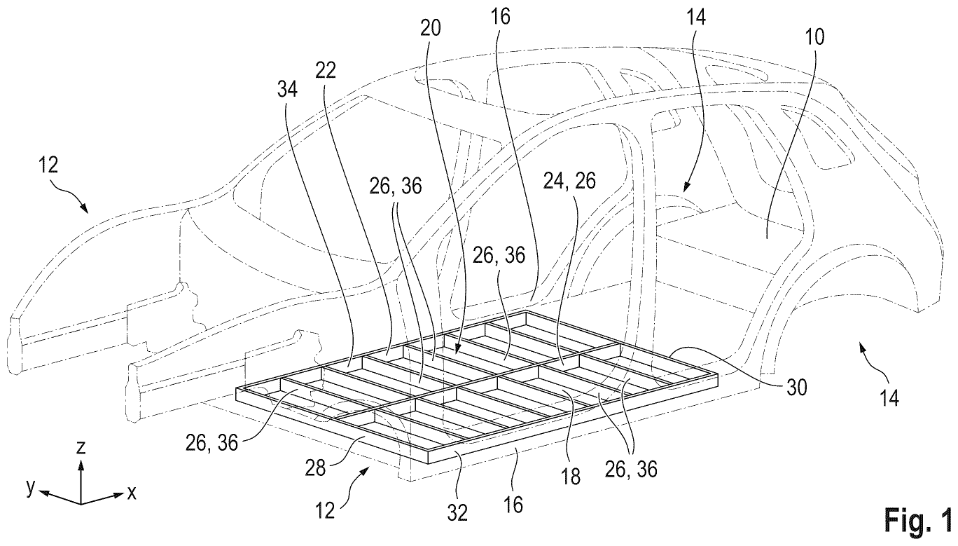

FIG. 1 shows a body shell 10 of a motor vehicle with two front wheel wells 12, two rear wheel wells 14, and side sills 16 extending between the wheel wells 12, 14 in the vehicle longitudinal direction (x direction). In the example shown, a battery casing 18 extends over the full length of the side sill 16 extending in the vehicle longitudinal direction (x direction) and across the full width extending in the vehicle transverse direction (y direction). This battery casing 18 has a rectangular basic shape with bottom portion 20, which likewise has a rectangular basic shape. Formed outside of the bottom portion 20 is a full-perimeter side wall 22 with a front portion 28, a rear portion 30, a left portion 32, and a right portion 34. The respective portions 28, 30, 32, 34 are designed as flat, plate-like elements with a flat, non-curved surface. Formed between the front portion 28 of the side wall 22 and the rear portion 30 of the side wall 22 is a central additional wall 26, which extends in the vehicle longitudinal direction (x direction). This additional wall 26 is designed as a longitudinal load path 24.

Furthermore, multiple additional walls 26 designed as transverse load paths 36, which extend in the vehicle transverse direction (y direction), are formed between the left portion 32, viewed in the direction of travel, of the side wall 22 and the right portion 34 of the side wall 22. The bottom portion 20 and the side wall 22 as well as the additional walls 26 are designed in one piece as a large cast part. In the example shown, the battery casing 18 that is formed as a large cast part is made of aluminum.

The battery casing 18 can alternatively also be made of other castable materials, wherein magnesium, graphite, and plastics, in particular, must be mentioned in addition to aluminum. All the said materials have a relatively low weight by volume. The materials aluminum, magnesium, and graphite have the further advantage that they have very good thermal conductivity, which is advantageous in particular for the removal of heat from battery cells and/or battery modules arranged in the battery casing 18. Improved heat removal can be achieved in battery casings 18 made of plastics when additives made of highly thermally conductive materials, in particular metallic additives, are added to the relevant plastic.

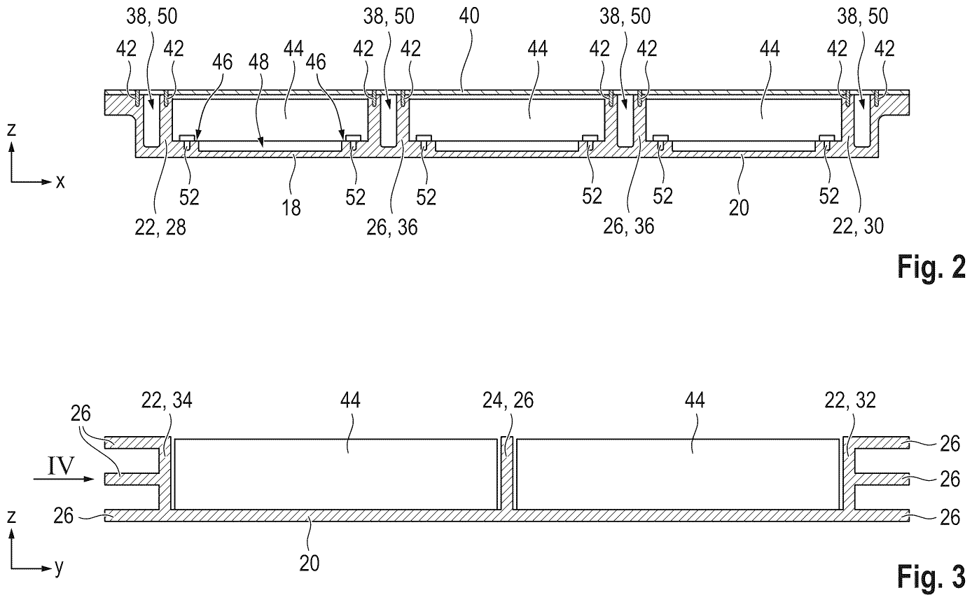

Additional examples are shown in FIGS. 2 to 9, wherein the same reference symbols as in FIG. 1 or a respective previously described example are used in each case for elements that are identical or at least have the same function. Please note that details of individual examples can be combined with one another in any manner not prohibited by logic in order to derive further examples from particulars of different examples. These possibilities for combination are considered to be obvious to the person skilled in the art within the scope of the present disclosure, and therefore are not additionally described in all variable variants.

FIG. 2 shows a longitudinal sectional view through a battery casing 18, which is constructed similarly to the battery casing 18 shown in FIG. 1 insofar as it likewise has a side wall 22 with a front portion 28 and a rear portion 30. Multiple additional walls 26 extending in the vehicle transverse direction (y direction), which are designed as transverse load paths 36, are likewise provided.

It is clearly visible from the sectional view that a cavity 38 that is upwardly open in the vehicle vertical direction (z direction) is formed in each of the side walls 22 extending in the vehicle transverse direction (y direction) as well as in each of the additional walls 26. The unilaterally, upwardly open cavity 38 is sealed at the top by a cover element 40, by the means that this cover element 40 is connected in a sealing manner to the battery casing 18. In the example shown, the connection is implemented by seal welding, which is visualized by the schematically represented welds 42. For this purpose, the cover element 40, which in the example shown is designed as a flat, thin plate, is advantageously made of the same material as the battery casing 18, here of aluminum, regardless of its geometric configuration. This is advantageous with regard to the joining process, in particular when the elements are to be welded together in a liquid-tight manner.

With regard to the welding method for seal welding, mention is made of laser welding and friction stir welding, in particular. Alternatively, a connection between cover element 40 and battery casing 18 can also be produced with other material-to-material manufacturing methods, in particular by adhesive bonding.

Fluid channels 50 extending in the vehicle transverse direction (y direction) are created by means of the unilaterally open cavities 38 formed in the side wall 22 and in the additional walls 26, and the sealing at the top by means of the cover element 40. Analogously thereto, corresponding fluid channels (not shown) are optionally also formed in the left portion and in the right portion of the side wall 22 as well as in any further additional walls 26 that may be present. One or more fluid paths that run through the walls 22, 26 of the battery casing 18 can be formed, in particular by producing fluidal connections between the fluid channels 50, for example by means of additional fluid channels (not shown) extending in the vehicle longitudinal direction (x direction).

It can also be seen in FIG. 2 that receiving regions are provided in the battery casing 18 for arranging battery modules 44. For this purpose, the height of the battery casing 18 extending in the vehicle vertical direction (z direction) is chosen to be taller than the height of the battery modules 44 so as to be able to arrange the modules completely inside the receiving regions.

Bottom supporting surfaces 46 for the battery modules 44 are provided only on the outside. A recess 48 is provided in the battery casing 18 between each of the supporting surfaces 46. These recesses can be used for coolant flows and/or thermally conductive elements or materials, in particular thermally conductive pads or thermally conductive pastes, can be arranged in these recesses 48 in order to improve the heat transfer from the battery modules 44 to the battery casing 18.

Possible attachment points can be formed in the battery casing 18 for the purpose of screwing in or screwing through, for example in order to screw the battery modules 44 to the battery casing 18 or in order to screw the battery casing 18 to elements of a vehicle body. In the example depicted in FIG. 2, the battery modules 44 can be screwed directly into the aluminum material of the battery casing 18 with flow drill screws 52.

FIG. 3 shows another example of a battery casing 18, which is shown in a cross-sectional view, which is to say sectioned in the vehicle transverse direction (y direction). The battery casing 18 has a bottom portion 20 and a side wall 22 with a left portion 32 and a right portion 34. Centered between the said side wall portions 32, 34 is an intermediate wall 26 designed as a longitudinal load path 24, which extends across the full length of the bottom portion 20, i.e., from the front side wall portion, not depicted, to the rear side wall portion, which likewise is not depicted.

Starting from the exterior of the depicted side wall portions 32, 34, three additional walls 26 each extend outward in the vehicle transverse direction, outside of the bottom portion 20. The additional walls 26 are arranged parallel to one another in the example shown, so that a forklike geometry with three fork prongs on each side is produced in the view from the front shown in FIG. 3.

Support structures can be optionally formed between the additional walls 26 extending outside the side wall portions 32, 34, such as, e.g., support ribs, support surfaces, or other support elements, which can be integrally molded in one piece or installed as separate elements. Such support elements can improve a controlled crash behavior of the additional walls 26 in the event of forces acting from outside by preventing the outer additional walls 26 from buckling outward. The probability that the additional walls 26 remain functional as a unit in the event of a crash and efficiently absorb kinetic energy by taking up maximum deformation energy is markedly increased in this way.

A cover element can also be provided, in particular to seal the battery casing 18 at the top.

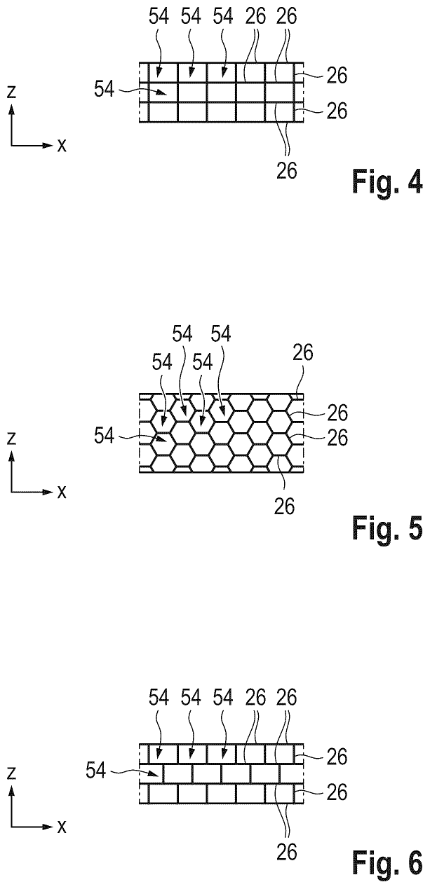

FIGS. 4 to 9 show different possibilities for how additional walls 26 designed as crash elements with closed substructures 54 can be configured in detail, analogous to the representation in FIG. 3, in a view corresponding to the arrow IV in FIG. 3.

In this case, the configurations in FIGS. 4 to 6 are substructures 54 that are arranged immediately adjacent to one another and are composed of additional walls 26. Accordingly, the result is a type of closed network made up of substructures 54 that are immediately adjacent to one another.

Provided as substructures 54 in the example shown in FIG. 4 are simple rectangular structures with four sides arranged at right angles to one another, which are arranged in regular rows as a grid structure.

In the example shown in FIG. 5, honeycomb elements are provided as substructures 54. This example is somewhat more complex in geometry, but has better crash behavior and higher shear stiffness.

Provided as substructures 54 in the example shown in FIG. 6 are rectangular structures arranged in immediately adjacent rows in a manner similar to those in FIG. 4, but in the example shown in FIG. 6, unlike the example shown in FIG. 4, immediately adjacent rows are arranged offset from one another by one half the distance of a side length. This results in improved shear stiffness and likewise improved crash behavior in comparison with the variant from FIG. 4.

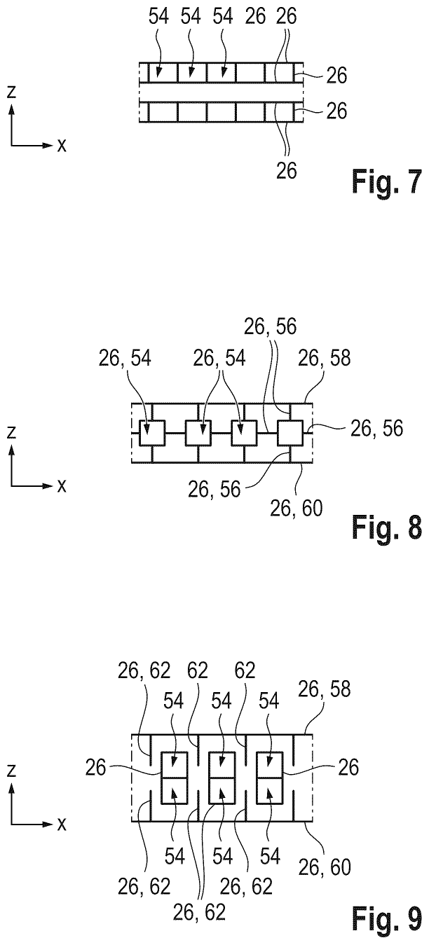

The examples shown in FIG. 7 can be formed of two rows of substructures 54 in the form of rectangles that immediately adjoin one another, wherein the rows are arranged parallel to one another and a certain distance apart. A weight-reduced configuration can be realized through the choice of a suitable distance in this way, in particular in order to keep from providing unnecessary auxiliary elements with a corresponding component weight through substructures 54 in certain vehicle areas where additional protection is already provided by further body elements (e.g., in the region of vehicle pillars, such as an A-pillar or B-pillar). Alternatively or in addition, spacing the rows apart from one another can take into account the circumstance that obstacles which potentially act on a motor vehicle from outside, such as, e.g., a tree trunk, pole, etc., usually have a certain minimum size. Accordingly, it can also be useful to choose the structural configuration shown in FIG. 7 with a certain distance between individual rows simply for the purposes of lightweight construction,.

In the examples shown in FIGS. 8 to 9, substructures 54 are formed from the additional walls 26 only in some places.

Rectangular structures are depicted by way of example as substructures 54.

As substructures 54, the example shown in FIG. 8 has individual rectangular structures, each of which has simple linear connecting walls 56 from a centered position of each side of the rectangle to a neighboring rectangular structure or to an upper wall 58 or to a lower wall 60. The areas where the connecting walls 56 adjoin the substructure 54 can be referred to as profile nodes or cast nodes, because the material there must/should flow as uniformly as possible in different directions during production by casting means.

As substructures 54, the example shown in FIG. 9 has rectangular structures in side-by-side pairs, which are arranged spaced apart from an upper wall 58 and a lower wall 60. Further individual walls 62 extend in each case from the upper wall 58 and from the lower wall 60, perpendicular thereto, in the direction of the spaces between the rectangular structures.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A battery casing, produced as a large cast part, for a motor vehicle, the battery casing comprising:
a bottom portion that has a width extending in a vehicle transverse direction and a length extending in a vehicle longitudinal direction;
at least one side wall that extends upward in a vehicle vertical direction, outside of the bottom portion, in order to laterally delimit, at least on one side, an interior for arranging battery cells and/or battery modules on the bottom portion; and
at least one additional wall extends upward from the bottom portion or extending outward, in relation to an area of the interior, from the bottom portion, the at least one additional wall being formed as a protective element.

2. The battery casing according to claim 1, wherein the at least one additional wall extends upward in the vehicle vertical direction from the bottom portion and is designed as a load path extending completely through the interior.

3. The battery casing according to claim 1, wherein the at least one additional wall extends outward in the vehicle transverse direction, outside of the bottom portion, and is designed as a crash element.

4. The battery casing according to claim 1, wherein the one additional wall is designed as a crash element or multiple additional walls are designed as crash elements, on every side facing outward in the vehicle transverse direction.

5. The battery casing according to claim 1, wherein the at least one additional wall is designed as a crash element and has a at least two closed substructures.

6. The battery casing according to claim 5, wherein the substructures are arranged directly adjacent to one another such that a largely homogeneous overall structure is produced, or wherein the substructures are spaced apart from one another by connecting structures such that a nonhomogeneous overall structure is produced.

7. The battery casing according to claim 1, wherein a fluid channel is formed in the at least one additional wall, at least in some places.

8. The battery casing according to claim 7, wherein the fluid channel is created by forming a unilaterally open cavity in the additional wall and by a fluid-tight sealing of the cavity with at least one separate element.

9. The battery casing according to claim 1, wherein at least one additional wall is designed as a longitudinal load path, wherein at least one additional wall is designed as a transverse load path, and/or wherein a fluid path is formed that extends through the side wall and at least one additional wall.

10. A motor vehicle comprising the battery casing according to claim 1, wherein the battery casing extends across a major part of the width of the motor vehicle.
